(19) United States
(12) Patent Application Publication
(10) Pub. No.: US 2012/0086963 A1
(43) Pub. Date: Apr. 12, 2012

(54) INFORMATION PROCESSING DEVICE TO GENERATE INFORMATION FOR DISTINGUISHING FORMS

(75) Inventors: Masahiro Fujitsuka, Kahoku-shi (JP); Takashi Sawada, Kahoku-shi (JP); Nobumitsu Ito, Kahoku-shi (JP); Tatsuya Mogi, Kahoku-shi (JP)

(73) Assignee: PFU LIMITED, Kahoku-shi (JP)

(21) Appl. No.: 13/223,732

(22) Filed: Sep. 1, 2011

(30) Foreign Application Priority Data
Oct. 12, 2010 (JP) 2010-229714

(51) Int. Cl. G06K 15/02

(52) U.S. Cl. 358/1.11; 358/1.18

(57) ABSTRACT

An information processing device according to the present invention includes a storage unit (11) to be stored with form definition data containing format definition of a form, an input unit (14) to capture image data of the form, and a control unit (12) to compare the image data captured by the input unit (14) with form definition data associated with the image data and generate information for distinction that enables the forms to be distinguished therebetween from components thereof by applying a result of the comparison to the form definition data.

### CROSS-REFERENCE TO RELATED APPLICATIONS

This application is based upon and claims the benefit of priority of the prior Japanese Patent Application No. JP2010-229714, filed on Oct. 12, 2010, the entire contents of which are incorporated herein by reference.

### FIELD

The present invention relates to an information processing device, an information processing method and a technology of a program, which generate form definitions and information for distinction between forms.

### BACKGROUND

In recent years, a paperless scheme has been promoted in a variety of operations (businesses, services) in terms of improving the operations and reducing costs, and nevertheless a good number of situations exist, in which paper (forms) such as transaction papers are still utilized. OCR (Optical Character Recognition) software has hitherto been employed for improving efficiency of the operation using this type of paper (forms). For example, a user distinguishes between the sheets of paper (forms) by utilizing the OCR software. Then, the user has been improving the operation efficiency by automatically classifying the sheets of paper (forms) such as grouping the sheets of paper (forms) on a category-by-category basis by making use of the distinguished result.

If a layout and a format of the paper (form) are improper, however, an OCR process is not conducted properly, with the result that the sheets of paper (forms) can not be classified. Hence, there is a necessity for creating the layout and the format of the paper (form), which is suited to the OCR process. Patent document 1 (Japanese Patent Application Laid-Open Publication No. H08-30659) and Patent document 2 (Japanese Patent Application Publication No. 3392530) given below disclose technologies therefor.

Patent document 1 discloses the technology of creating a fixed form recognized by the OCR to be used in a manner that specifies a type of the OCR to be used, a row field count and a character count. Further, Patent document 2 discloses the technology of generating OCR definition information (data) while calculating an area in which the same format as seen in a multi-entry form is repeated.

The technologies disclosed in Patent document 1 and Patent document 2 described above do not, however, take into consideration fluctuations of peripheral environments such as a deviation of a print position due to using a different type of printer and a deflection of the form when a scanner captures data of the form. Therefore, the technologies disclosed in Patent document 1 and Patent document 2 described above are incapable of properly creating the information for distinction that is used for a user to distinguish between the forms from components thereof.

### SUMMARY

According to an aspect of the invention, an information processing device includes a storage unit to be stored with form definition data containing format definition of a form, an input unit to capture image data of the form, and a control unit to compare the image data captured by the input unit with form definition data associated with the image data and generate information for distinction that enables the forms to be distinguished therebetween from components thereof by applying a result of the comparison to the form definition data.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating devices connected to an information processing device according to an embodiment.

FIG. 2 is a block diagram illustrating a configuration of the information processing device according to the embodiment.

FIG. 3 is a diagram illustrating a form.

FIG. 4 is a diagram illustrating records of a form definition database according to the embodiment.

FIG. 5 is a diagram illustrating records of a form classifying definition database according to the embodiment.

FIG. 6 is a flowchart illustrating one example of processing procedures when generating form definition data according to the embodiment.

FIG. 7 is a flowchart illustrating one example of processing procedures when generating form classifying definition data according to the embodiment.

### DESCRIPTION OF EMBODIMENT

An information processing device, an information processing method and a program according to one aspect of the present invention will hereinafter be discussed by way of an embodiment (which will hereinafter be referred to as [the present embodiment] or simply [the embodiment]). The embodiment which will be given as below is, however, an exemplification, and the present invention is not limited to a configuration of the following embodiment.

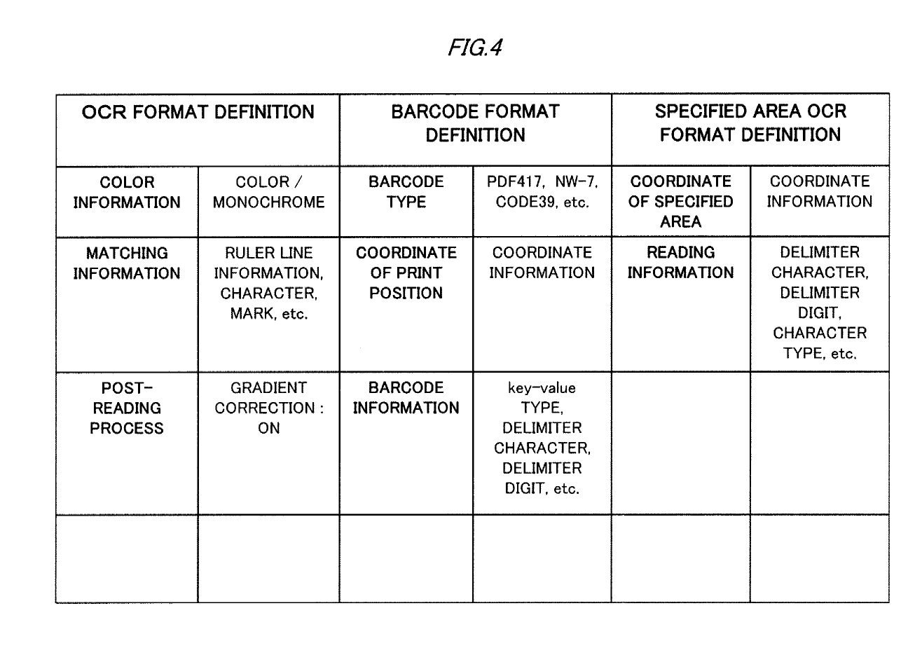

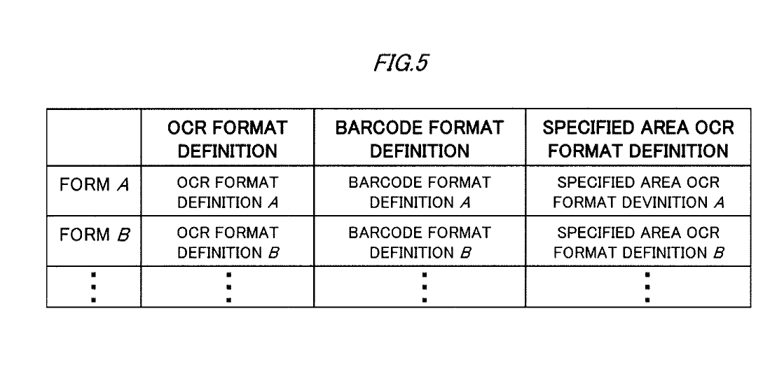

Note that in the embodiment which will hereinafter be given, a field name etc in a record example of a database in FIGS. 4 and 5 is exemplified in a natural language (English etc), however, more specifically, such an element is specified by a pseudo-language, a command, a parameter, a machine language, etc, which can be recognized by a computer.

### §1 Example of Connection Between Respective Devices

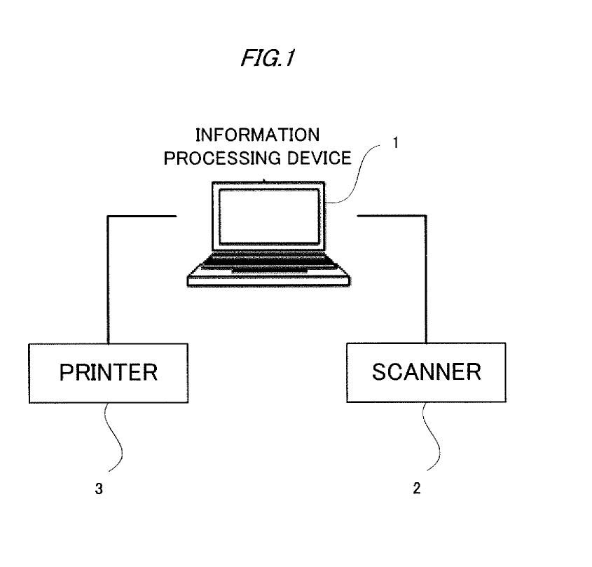

The discussion will start with exemplifying devices connected to the information processing device according to the embodiment. FIG. 1 illustrates the devices connected to the information processing device according to the embodiment. As illustrated in FIG. 1, an information processing device 1 according to the embodiment is connected to a scanner 2 and a printer 3. The scanner 2 and the printer 3 are connected to the information processing device 1 in a status of being controllable by the information processing device 1.

In the embodiment, the information processing device generates form definition data which contains format definitions of forms and form classifying definition data which contains classifying definitions which enable the forms to be classified based on components (items of data). Note that the classifying of the forms connotes, e.g., grouping the forms according to the same classification (on a category-by-category basis), and so on. The information processing device 1 distinguishes between the forms on the basis of the form classifying definition data. Then, the information processing device 1 classifies the forms on the basis of a result of the distinction. The form classifying definition data is given by way of one example of distinguishing information which enables the forms to be distinguished based on components thereof according to the present invention.

Note that operations of the respective devices (the information processing device 1, the scanner 2, the printer 3) are, as a matter of course, not limited to the processes in the embodiment.

### §2 Example of Configuration of Information Processing Device 1

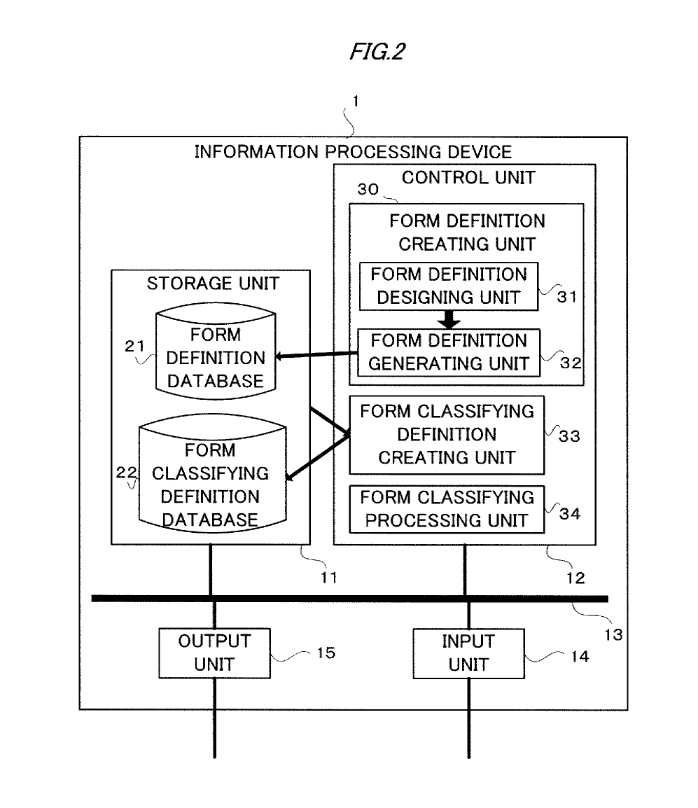

Next, an example of a configuration of the information processing device 1 according to the embodiment will be described. FIG. 2 illustrates the example of the configuration of the information processing device 1 in the embodiment.

The information processing device 1 has, as illustrated in FIG. 2, a hardware configuration which includes existing hardware components such as a storage unit 11, a control unit 12, an input unit 14 and an output unit 15, which are connected to each other via a bus 13. The storage unit 11 is, e.g., a hard disc stored with a variety of data and programs that are used in the processes executed by the control unit 12. The control unit 12 is constructed of a single or a plurality of processors such as a CPU (Central Processing Unit) and includes peripheral circuits (such as a ROM (Read Only Memory), a RAM (Random Access Memory) and an interface circuit) used in the processes of the processor. The input unit 14 is an interface for receiving image data and test data that are captured by the scanner 2. Further, the output unit 15 is an interface for outputting form data for a recognition test to the printer 3. Moreover, unillustrated user interfaces (input/output devices such as a monitor, a keyboard and a mouse) are connected to the information processing device 1 in the embodiment.

Note that the information processing device 1 may be constructed of a general-purpose computer such as a PC (Personal Computer).

Furthermore, another mode of the embodiment is that if the information processing device 1 is connected via a network to the scanner 2 and the printer 3, the input unit 14 and the output unit 15 are configured as a communication unit which transmits and receives, e.g., IP (Internet Protocol) packets etc.

In the embodiment, the information processing device 1, with the control unit 12 processing the data stored in the storage unit 11, generates the form definition data containing format definitions of the forms and generates the form classifying definition data specifying the classifying definitions which enable the forms to be classified based on the components thereof. Further, in the embodiment, the information processing device 1, with the control unit 12 processing the data stored in the storage unit 11, executes classifying the forms.

To begin with, before specifically describing the storage unit 11 and the control unit 12 for realizing the processes described above, a brief description of the forms will be made.

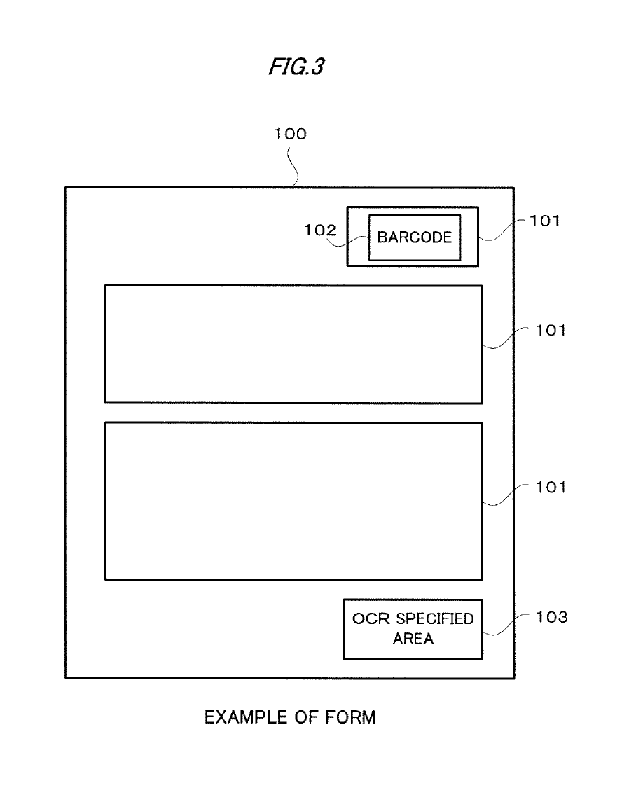

FIG. 3 illustrates an example of the form. A form 100 depicted in FIG. 3 contains fields 101, a barcode 102 and an OCR specified area 103. The fields 101 are used for handwriting, imprinting or stamping information on operations (businesses, services, etc). Further, the barcode 102 is stored with, e.g., classification information of the forms and individual identification numbers of the forms. Note the barcode 102 may also be stored with plural items of information such as retaining the classification information and the individual identification numbers of the forms. Moreover, the OCR specified area 103 is defined as an area where a specified area OCR is executed. The OCR of the specified area connotes extracting character information by executing the OCR process over the specified area alone. Written to this area are, e.g., the classification information of the forms and specified items of information on the operations. Thus, the form contains, as the components thereof, the fields, the barcode and the OCR specified area.

In the embodiment, the information processing device 1 generates the form definition data containing the format definitions of these forms. Further, the information processing device 1 generates the form classifying definition data which specify the classifying definitions for classifying (distinguishing between) these forms. Still further, the information processing device 1 executes classifying the forms. Note that the information processing device 1 executes a pattern matching process of external appearance such as layout, the OCR process or an OMR (Optical Mark Recognition) process with respect to the components of the forms, thereby implementing the classifying (distinction) of the forms. The storage unit 11 and the control unit 12 of the information processing device 1 will hereinafter be specifically described.

§2-1 Storage Unit 11

As illustrated in FIG. 2, the storage unit 11 includes a form definition database 21 and a form classifying definition database 22. The form definition database 21 and the form classifying definition database 22 are realized as, e.g., data stored in the hard disc.

<Form Definition Database 21>

The form definition database 21 is stored with the form definition data. The form definition data is the data containing the format definition of the form. For example, the form definition data is prepared on the category-by-category basis with respect to the form. Then, as for the form definition data, the form based on the form definition data is printed by a printer etc and is then used for the operation.

FIG. 4 illustrates an example of a record (the form definition data) of the form definition database 21 in the embodiment. As illustrated in FIG. 4, the form definition data in the embodiment contains an OCR format definition field, a barcode format definition field and a specified area OCR format definition field.

The OCR format definition field is stored with items of information such as a mode and a layout of the component (field etc) of the form. For instance, as illustrated in FIG. 4, the OCR format definition field is stored with color information, matching information, post-reading process information, etc which are used in the form.

The color information connotes information of a color used in the form. For example, as depicted in FIG. 4, the color or a monochrome is specified.

The matching information connotes information about the layout etc of the components of the form, and contains ruler line information and pieces of information of characters and marks to be used. Note that the ruler line information is information about the ruler line used in the form and is exemplified such as on-form position information of the ruler line. The on-form position information of the ruler line is defined by, e.g., a formula of a condition satisfied by the ruler line and a known method such as coordinates. The coordinates are whole coordinates in which, for example, a left upper angular corner of the form is set to (0, 0).

The post-reading processing information is information on the process carried out when the form is converted into electronic data by the scanner etc. Note that [Gradient Correction ON] illustrated in FIG. 4 indicates executing a function of correcting a gradient of the reading image, which is conducted by a known method.

Thus, the information stored in the OCR format definition field is information on an external appearance such as a layout of the form, and the OCR format definition is given as one example of the format definition which defines the format related to the external appearance of the form according to the present invention. Note that in the embodiment the matching information stored in the OCR format definition field is used in a pattern matching process when classifying the form. It should be also noted that, e.g., the information processing device 1 recognizes the external appearance such as the layout of the components of the classifying target form, and obtains a matching rate depending on how much a pattern of the external appearance matches with the matching information. Then, the information processing device 1 classifies the classifying target form as a form having the matching information with the obtained matching rate that is over a predetermined value.

The barcode format definition field is stored with information of the barcode used in the form. For instance, as illustrated in FIG. 4, the barcode format definition field is formed with information indicating a type of the barcode, information representing coordinates of a print position in which the barcode is printed, and barcode information indicating a data format of the barcode. Note that the barcode format definition is given by way of one example of the format definition which defines a mark attribute value for recognizing an optical mark included in the form according to the present invention. Note that the mark for recognizing the optical mark connotes, specifically, a mark sheet and a barcode and is a mark capable of storing predetermined information and entered or printed on the paper etc in accordance with a predetermined rule. Then, the attribute value of the mark for recognizing the optical mark represents information about a mark-attached position on the form, a size of the mark and predetermined information stored in the mark. The information processing device 1 according to the embodiment executes classifying the form by OMR-processing the component (barcode) of the classifying target form.

The information representing the type of the barcode indicates a type of the barcode used in the form. The type of the barcode used in the form is arbitrarily set and is exemplified such as PDF417, NW-7 and CODE39 illustrated in FIG. 4.

The information representing the coordinates of the print position where the barcode is printed, indicates the coordinates of the position in which the barcode is printed on the form. The coordinates of the position may be expressed as an arbitrary format. For example, the coordinates of the position of the barcode are coordinates of the central position of the barcode in the whole coordinates, in which the left upper angular corner of the form is set to (0, 0). Further, for instance, the coordinates of the position of the barcode are the coordinates of the left upper angular corner of the print area of the barcode in the whole coordinates in which the left upper angular corner of the form is set to (0, 0). Note that the information representing the coordinates of the print position in which the barcode is printed may contain information about a range of the print area of the barcode. In the embodiment, this item of information is used for determining the position of acquiring the barcode in the form classifying process.

The barcode information represents a data format and the information about the data that are stored in the barcode. For example, the barcode information includes information about a data format of data stored in the barcode such as [key-value type], [delimiter character] and [delimiter digit] and includes information about the data retained in the barcode, together. Note that [key-value type], [delimiter character] and [delimiter digit] given herein are pieces of information each specifying a method of reading the data stored in the barcode. The information indicating the reading position is designated by such a rule (format) that a part subsequent to a certain delimiter character is defined as reading target data.

Herein, the data retained in the barcode contains information for classifying the forms. The information for classifying the forms is category information for distinguishing between categories of the forms and is, in the embodiment, employed in the form classifying process. Note that the barcode may be stored with, in addition to those described above, the individual identification number of the form. Moreover, the barcode may also be stored with plural items of information such as being stored with the category information, the individual identification number, etc of the form.

The specified area OCR format definition field is stored with the information on the specified area OCR carried out for the form. For instance, as illustrated in FIG. 4, the specified area OCR format definition field is stored with the information representing the coordinates of the specified area where the specified area OCR is conducted, the reading information that should be read by the specified area OCR, and so forth. Note that the specified area OCR format definition is given as one example of the format definition which specifies the attribute value related to the character recognition executed in the specified area according to the present invention. The attribute value related to the character recognition implemented in the specified area represents the position information on the form with respect to the specified area in which the character recognition is implemented, area information and character information described in the specified area. The information processing device 1 according to the embodiment executes classifying the forms by OCR-processing the components of the classifying target form.

The information representing the coordinates of the specified area represents the coordinates of the position on the form undergoing the implementation of the specified area OCR. For example, the coordinates of the position of the specified area are the coordinates of the central position of the specified area in the whole coordinates, in which the left upper angular corner of the form is set to (0, 0). Further, for instance, the coordinates of the position of the specified area are the coordinates of the left upper angular corner of the specified area in the whole coordinates, in which the left upper angular corner of the form is set to (0, 0). Incidentally, the information representing the coordinates of the specified area may contain the information about the range of the specified area. In the embodiment, this information is employed for determining the position in which to perform the specified area OCR in the form classifying process.

The reading information represents a data format and the information on the data that are stored in the specified area. For example, the reading information includes such as [delimiter character], [delimiter digit] and [character type] which is information about the data format of the data registered in the specified area and is stored with the information about the data registered in the specified area, together. This point is the same with the [barcode information] described above.

Further, similarly to the barcode information, the reading information includes the information for classifying the forms. This information for classifying the forms is category information for distinguishing between the categories of the forms and is, in the embodiment, used in the form classifying process. Note that the reading information may include, in addition to those described above, the individual identification number of the form. Moreover, the reading information may also include plural items of information such as being stored with the category information, the individual identification number, etc of the form.

It should be noted that in another mode of the embodiment, the form definition data may not necessarily contain all of the OCR format definition, the barcode format definition and the specified area OCR format definition. For example, the form definition data may contain at least one format definition or a plurality of format definitions among the OCR format definition, the barcode format definition and the specified area OCR format definition.

Furthermore, the form definition data is not limited to the OCR format definition, the barcode format definition and the specified area OCR format definition. The form definition data may be, if related to the form format, data other than the OCR format definition, the barcode format definition and the specified area OCR format definition.

<Form Classifying Definition Database 22>

The form classifying definition database 22 is stored with the form classifying definition data. The form classifying definition data is the data which gives a rule of how the forms are classified based on the components thereof, and is prepared, e.g., per operation sector. Then, the form classifying definition data is employed for classifying the forms (e.g., for grouping the forms on the category-by-category basis) converted into the electronic data by the scanner or the like in, e.g., the operation sector.

FIG. 5 illustrates an example of the record (of the form classifying definition data) of the form classifying definition database 22 in the embodiment. As illustrated in FIG. 5, the form classifying definition data in the embodiment contains an OCR format definition field, a barcode format definition field and a specified area OCR format definition field. Then, the form classifying definition data in the embodiment is stored with an OCR format definition, a barcode format definition and a specified area OCR format definition per form classifying target (e.g., per category of the form). Herein, the OCR format definition, the barcode format definition and the specified area OCR format definition are the same as those in the form definition data described above, and hence their explanations are omitted.

It should be noted that in another mode of the embodiment, the form classifying definition data may not necessarily contain all of the OCR format definition, the barcode format definition and the specified area OCR format definition. For example, the form classifying definition data may contain at least one format definition or a plurality of format definitions among the OCR format definition, the barcode format definition and the specified area OCR format definition.

Further, the form classifying definition data is limited to neither the OCR format definition nor the barcode format definition nor the specified area OCR format definition. The form classifying definition data may be, if used for classifying the forms, data other than the OCR format definition, the barcode format definition and the specified area OCR format definition.

§2-2 Control Unit 12

As illustrated in FIG. 2, the control unit 12 includes a form definition creating unit 30, a form classifying definition creating unit 33 and a form classifying processing unit 34. The form definition creating unit 30, the form classifying definition creating unit 33 and the form classifying processing unit 34 are realized in such a way that a program etc stored in the storage unit 11 is deployed on the RAM defined as the peripheral circuit of the control unit 12 and is executed by the processor of the control unit 12.

As described above, the control unit 12 generates the form definition data and the form classifying definition data and executes the form classifying process by use of the information stored in the storage unit 11. Respective configurations will hereinafter be described.

<Form Definition Creating Unit 30>

The form definition creating unit 30 generates the form definition data. As depicted in FIG. 2, the form definition creating unit 30 includes a form definition designing unit 31 and a form definition generating unit 32. The form definition designing unit 31 and the form definition generating unit 32 are realized in such a way that a program etc stored in the storage unit 11 is deployed on the RAM defined as the peripheral circuit of the control unit 12 and is executed by the processor of the control unit 12.

In the embodiment, the form definition designing unit 31 acquires the data for creating the form in a manner that corresponds to the input information from the user via the user interface. The form definition designing unit 31 provides the user with, e.g., an arbitrary interface for inputting the information via the user interface in order to acquire the data for creating the form. For example, the form definition designing unit 31 provides, as an arbitrary interface, an interface for presenting a known rendering tool and selective information to the user. The user operates the rendering tool via the user interface such as the mouse and the keyboard, performs an operation of determining the selective information, designing the fields of the form as illustrated in FIG. 3, inputs the barcode information and determines the area in which the specified area OCR is carried out. Further, the user inputs via the interface the barcode and the information for distinguishing between the forms, which is stored in the area where the specified area OCR is conducted. This input operation is performed for storing the information in the respective items of the format definition field of the form definition data described above. The form definition designing unit 31 outputs these pieces of input information to the form definition generating unit 32 in order to generate the form definition data.

The form definition generating unit 32 generates the form definition data on the basis of the data for creating the form that is received from the form definition designing unit 31. To be specific, the form definition generating unit 32 prepares the form definition data (the records illustrated in FIG. 4) in an empty status of the data, and stores the user-based input information received from the form definition designing unit 31 in the respective items in a predetermined format, thus generating the form definition data. At this time, if the data for creating the form received from the form definition designing unit 31 has a discrepancy from the data format of the form definition data, the form definition generating unit 32 executes a conversion into the predetermined data format. Then, the form definition generating unit 32 stores the data for creating the form undergoing the execution of the conversion into the data format in each of the items of the form definition data.

Through the processes described above, all the data for creating the form received from the form definition designing unit 31 are stored in the respective items of the form definition data, at which time the form definition generating unit 32 completes the generation of the form definition data. Then, the form definition generating unit 32 stores the completely-generated form definition data in the form definition database 21.

Note that at this time the information is not necessarily stored in all of the fields of the form definition data. For instance, the information may be stored in only the OCR format definition field. In the embodiment, however, if disabled from generating the form data due to deficiency of the input information from the user, the form definition designing unit 31 or the form definition generating unit 32 displays, e.g., that the input information is deficient on the user interface (a monitor etc), and executes an error process such as stopping the process. Note that “the case of being disabled from generating the form data due to deficiency of the input information from the user” is, e.g., a case where none of the information of the form is specified, and so on.

<Form Classifying Definition Creating Unit 33>

The form classifying definition creating unit 33 generates the form classifying definition data. The form classifying definition creating unit 33 generates the form classifying definition data on the basis of the form definition data and image data inputted to the input unit 14. It is to be noted that the generation of the form classifying definition data includes updating the already-generated form classifying definition data.

In the embodiment, the form classifying definition creating unit 33 acquires the form definition data from the form definition database 21. Note that when acquiring the form definition data, the form classifying definition creating unit 33 executes a process of checking (checking the data format) whether the acquired data is the form definition data or not. The form classifying definition creating unit 33 executes the checking process by collating, e.g., a check list prepared beforehand.

Further, in the embodiment, the form classifying definition creating unit 33 accepts an input of the image data in order to generate the form classifying definition data. For example, the form classifying definition creating unit 33 acquires the image data from the input unit 14. The image data is the data (electronic data) into which the form data generated based on the form definition data is converted into electronic data by the scanner 2 which captures the image of the form printed by the printer 3. Note that the image data may also be the electronic data converted by the scanner 2 which captures the image of the form created by the user who handwrites, imprints or attaches a seal etc in accordance with, e.g., the form definition data. The form, which is converted into the electronic data by the scanner 2, may also be an arbitrary form. Then, the form, which is converted into the electronic data by the scanner 2, is inputted as the image data to the input unit 14, whereby the form classifying definition creating unit 33 acquires the image data from the input unit 14. Note that the form classifying definition creating unit 33 may acquire plural pieces of image data and may also acquire the single piece of image data. Furthermore, the image data may also be arbitrarily inputted such as being inputted via, e.g., the network to the information processing device 1.

The form classifying definition creating unit 33, upon acquiring the image data from the input unit 14, specifies the form definition data associated with the acquired image data (form) from within the acquired form definition data. This process is arbitrarily executed. The form classifying definition creating unit 33 may specify the form definition data on the basis of the information (the selective information of the form definition data) inputted by the user via, e.g., the user interface.

Further, the form classifying definition creating unit 33 may also specify the form definition data associated with the acquired image data by randomly selecting each format definition contained in the acquired form definition data and collating the selected format definition with the acquired image data.

For instance, the OCR format definition is used for the collation, in which case the form classifying definition creating unit 33 collates the image data by use of the OCR format definition stored in the form definition data. Specifically, the form classifying definition creating unit 33 conducts the collation by performing the pattern-matching with the image data in a way that employs the matching information stored in the OCR format definition field of the form definition data. Then, the form classifying definition creating unit 33 specifies the form definition data having the matching information of which the matching rate is over the predetermined matching rate, as the form definition data associated with the image data. Note that the predetermined matching rate is arbitrarily set for providing flexibility to the operation against an error due to the peripheral environments of the printer 3 and the scanner 2 and an error due to the handwriting and the imprinting of the user.

Moreover, for example, if the barcode format definition is used for the collation, the form classifying definition creating unit 33 collates the image data by use of the barcode format definition stored in the form definition data. Specifically, the form classifying definition creating unit 33 specifies the position of acquiring the barcode on the basis of the coordinate information of the print position of the barcode, which is stored in the barcode format definition field of the form definition data. The form classifying definition creating unit 33 acquires the barcode with respect to an arbitrary predetermined area in the way of setting the barcode print position as a benchmark in order to provide, as described above, the flexibility to the operation against the error due to the peripheral environments of the printer 3 and the scanner 2 and the error due to the handwriting and the imprinting of the user. With respect to the form definition data with the barcode being acquired through this process, the form classifying definition creating unit 33 specifies the form definition data associated with the image data on the basis of the barcode information. The form classifying definition creating unit 33 recognizes, based on the information representing the type of the barcode stored in the barcode format definition field, the type of the barcode and decodes this barcode. Then, the form classifying definition creating unit 33 specifies the form definition data associated with the image data from the data of the decoded barcode and the information for classifying the form, which is contained in the barcode format definition field. Note that if unable to acquire, e.g., the barcode in the process described above and if unable to decode the barcode, the form definition data stored with the relevant information is not the form definition data associated with the image data. Accordingly, the form classifying definition creating unit 33 deals with these pieces of form definition data not as the form definition data associated with the image data. For example, however, there might be a case in which none of the barcode is acquired with respect to all the form definition data because of the error being over the set-up arbitrary predetermined area. In such a case, the form classifying definition creating unit 33 may obtain the barcode by searching the whole image data for the barcode. Further, if the plurality of barcodes is detected in this process, the form classifying definition creating unit 33 may specify the barcode used for the collation by an arbitrary method. For instance, the form classifying definition creating unit 33 may specify the barcode used for the collation on the basis of the information (the selective information of the barcode) inputted by the user via the user interface.

Moreover, for instance, when the specified area OCR format definition is used for the collation, the form classifying definition creating unit 33 collates the image data by employing the specified area OCR format definition stored in the form definition data. To be specific, the position and the area where the specified area OCR is carried out are specified based on the coordinate information of the specified area, which is stored in the specified area OCR format definition field of the form definition data. The form classifying definition creating unit 33 implements, for providing the flexibility to the operation against the error due to the peripheral environments of the printer 3 and the scanner 2 and the error due to the handwriting and the imprinting of the user, the specified area OCR over the arbitrary predetermined area in the way of setting the coordinate information of the specified area as the benchmark. With respect to the form definition data with the information being acquired through this process, the form classifying definition creating unit 33 specifies the form definition data associated with the image data. The form classifying definition creating unit 33 specifies the form definition data associated with the image data from the acquired information and from the information for classifying the forms that is contained in the reading information stored in the specified area OCR format definition field. Note that if disabled from acquiring the information through, e.g., the specified area OCR in the process described above, the form definition data stored with this information is not the form definition data associated with the image data. Accordingly, the form classifying definition creating unit 33 treats these pieces of form definition data not as the form definition data associated with the image data.

Note that there exist plural sets of form definition data associated with the image data, in which case the form classifying definition creating unit 33 specifies the form definition data associated with the acquired image data by an arbitrary method. The form classifying definition creating unit 33 performs the collation by using, e.g., the plurality of format definitions, and specifies the form definition data exhibiting a larger number of matched format definitions as the form definition data associated with the acquired image data. Further, for example, the form classifying definition creating unit 33 displays the plural sets of form definition data on the user interface and may accept the input information from the user. In this case, the form classifying definition creating unit 33 specifies the form definition data corresponding to the input information (the selection of the form definition data) given from the user as the form definition data associated with the image data. With this contrivance, the form classifying definition creating unit 33 specifies the form targeted at creating the classifying definition. In the embodiment, the form classifying definition creating unit 33 obtains a form name ([Form A], [Form B], etc) illustrated in FIG. 5.

Through the process described above, the form classifying definition creating unit 33 generates the form classifying definition data by using the image data acquired from the input unit 14 and the form definition data associated with the image data. Note that in the embodiment, at this point of time, the form classifying definition creating unit 33 retains the classifying definition data (corresponding to row data of the form classifying definition data illustrated in FIG. 5) with a name label of the form being specified. At this point time, however, any data is not stored in each format definition field of the classifying definition data. Further, in the embodiment, at this point of time, the form classifying definition creating unit 33 retains the form classifying definition data not stored with any information.

When the OCR format definition is used for classifying the forms, the form classifying definition creating unit 33 acquires, from the OCR format definition field of the form definition data, the information to be stored in the OCR format definition field of the classifying definition data. Then, the form classifying definition creating unit 33 performs the pattern-matching of the image data on the basis of the matching information contained in the information obtained from the OCR format definition field of the form definition data. With this pattern-matching, the form classifying definition creating unit 33 obtains an error between the ruler line information etc specified by the matching information and the image data, and generates the matching information with the error being modified (corrected). Then, the form classifying definition creating unit 33 stores the OCR format definition field of the classifying definition data with the thus-generated matching information and the information other than the matching information stored in the OCR format definition field of the form definition data.

Note that if the plural pieces of image data are acquired with respect to the same form, the form classifying definition creating unit 33 may obtain errors (e.g. an average of the errors) between the plural pieces of image data by a known mathematical technique (algorithm). Then, the form classifying definition creating unit 33 may modify (correct) the coordinate information etc of the matching information from the obtained error.

Moreover, the modification (correction) may be changed based on the post-reading processing information stored in the OCR format definition field. For example, if the post-reading processing information indicates that a gradient of the readout image is to be corrected, the form classifying definition creating unit 33 may modify (correct) the coordinate information etc of the matching information with an error smaller than the obtained error.

Further, the form classifying definition creating unit 33 arbitrarily determines whether the OCR format definition is used for classifying the forms or not. This determination may be made by setting parameters of the program etc stored in the storage unit 11 and may also be made depending on whether the OCR format definition is stored in the form definition data associated with the image data. Moreover, this determination may also be made based on the input information given from the user via the user interface. As for this point, the determination is the same as the determination as to whether the following barcode format definition is used for classifying the forms or not and is also the same as the determination as to whether the specified area OCR format definition is used for classifying the forms or not.

Next, when the barcode format definition is used for classifying the forms, the form classifying definition creating unit 33 obtains the information to be stored in the barcode format definition field of the classifying definition data from the barcode format definition field of the form definition data. Then, the form classifying definition creating unit 33 detects the barcode from the image data on the basis of the information (position coordinates of the barcode) indicating the coordinates of the print position in which to print the barcode contained in the information obtained from the barcode format definition field of the form definition data. Note that this detection involves, in the same way as specifying the form definition data described above, taking into consideration the error due to the peripheral environments of the printer 3 and the scanner 2 and the error due to the handwriting and the imprinting of the user.

If the barcode can be detected, the form classifying definition creating unit 33 acquires the position coordinates of the barcode on the image data, and calculates an error (discrepancy) between the acquired position coordinates and the position coordinates of the barcode obtained from the barcode format definition field of the form definition data.

Whereas if the barcode can not be detected, the form classifying definition creating unit 33 may acquire the barcode by searching for the barcode from the entire image data. Further, if the plurality of barcodes is detected in this process, the form classifying definition creating unit 33 may specify the barcode used for the classifying by the arbitrary method. For example, the form classifying definition creating unit 33 may specify the barcode used for the classifying on the basis of the information (the selective information of the barcode) inputted from the user via the user interface. The form classifying definition creating unit 33 acquires the position coordinates of the barcode detected in this process, and calculates an error between the acquired position coordinates and the position coordinates obtained from the barcode format definition field of the form definition data.

Note that the modification (correction) of the error describe above is the same as the modification (correction) of the coordinate information of the matching information, and hence the explanation thereof is omitted. The form classifying definition creating unit 33 stores, in the barcode format definition field of the classifying definition data, the information on the error-modified (error-corrected) position coordinates of the barcode and the information other than the coordinate information of the print position of the barcode format definition field of the form definition data.

Moreover, if the barcode can not be detected from the entire image data, the form classifying definition creating unit 33 may determine that the barcode format definition is not employed for classifying the forms and may also store the information registered in the barcode format definition field of the form definition data in an as-is status in the barcode format definition field of the classifying definition data. Namely, the form classifying definition creating unit 33 may store the information registered in the barcode format definition field of the form definition data in the barcode format definition field of the classifying definition data without making the modification (correction).

Next, when the specified area OCR format definition is used for classifying the forms, the form classifying definition creating unit 33 acquires, from the specified area OCR format definition field of the form definition data, the information to be stored in the specified area OCR format definition field of the classifying definition data. Then, the form classifying definition creating unit 33 executes the specified area OCR over the image data on the basis of the information (the position coordinates of the specified area) representing the coordinates of the specified area undergoing the execution of the specified area OCR that is contained in the information obtained from the specified area OCR format definition field of the form definition data. Note that the execution of the specified area OCR involves, in the same way as specifying the form definition data described above, taking into the consideration the error due to the peripheral environments of the printer 3 and the scanner 2 and the error due to the handwriting and the imprinting of the user.

If the information can be obtained from the specified area, the form classifying definition creating unit 33 acquires the position coordinates in which the relevant information on the image data can be obtained, and calculates an error between the acquired position coordinates and the position coordinates of the specified area obtained from the specified area OCR format definition field of the form definition data.

The modification (correction) of the error describe above is the same as the modification (correction) of the coordinate information of the matching information, and hence the explanation thereof is omitted. The form classifying definition creating unit 33 stores, in the specified area OCR format definition field of the classifying definition data, the information on the error-modified (error-corrected) position coordinates of the specified area and the information other than the coordinate information of the position of the specified area of the specified area OCR format definition field of the form definition data.

Whereas if the information can not be obtained from the specified area, the form classifying definition creating unit 33 may determine that the specified area OCR format definition is not employed for classifying the forms and may also store the information registered in the specified area OCR format definition field of the form definition data in the as-is status in the specified area OCR format definition field of the classifying definition data.

Through the processes described above, the form classifying definition creating unit 33 generates the classifying definition data of which the OCR format definition field, the barcode format definition field and the specified area OCR format definition field are each stored with the information (in the way of including a case where the information is not stored in each of the fields). Then, the form classifying definition creating unit 33 stores the thus-generated classifying definition data as the row data of the form classifying definition data.

In the embodiment, the form classifying definition creating unit 33 iterates the processes described so far, thus generates the form classifying definition data set by the user or inputted as the image data, and adds the generated classifying definition data as the row data to the form classifying definition data. Subsequently, the form classifying definition creating unit 33, when the forms targeted at the should-be-generated classifying definition data are consumed up, determines to finish generating the classifying definition data, thereby completing the classifying definition data adding process. Namely, the form classifying definition creating unit 33 completes generating the form definition data. It is to be noted that the time “when the forms targeted at the should-be-generated classifying definition data are consumed up” implies the time when all the form classifying definition data set by the user or inputted as the image data are generated, and the row data of the form classifying definition data is added in the embodiment. The form classifying definition creating unit 33 may again accept the input of the image data for further generating the classifying definition data.

In the embodiment, the information processing device 1 performs, together with generating the form classifying definition data, a recognition test for measuring a form classifying recognition rate (corresponding to a distinction rate according to the present invention) which uses each format definition. The form classifying implementation is processed by the form classifying processing unit 34 that will be described later on, and therefore the recognition test will hereinafter be described.

In the case of performing the recognition test, the form classifying processing unit 34, which will be described later on, measures the form classifying rate (recognition rate) based on the respective format definitions as a result of executing the form classifying process by use of the form classifying definition data of which the generation has been completed by the form classifying definition creating unit 33. Then, the form classifying definition creating unit 33 receives the recognition rate of the form with respect to each format definition from the form classifying processing unit 34 and sets a priority level used for classifying the forms with respect to each format definition. For example, the form classifying definition creating unit 33 allocates a higher priority level to the format definition exhibiting a higher recognition rate. The priority level may be allocated per classifying definition data and may also be allocated to the whole form classifying definition data without distinguishing between respective sets of the classifying definition data. Then, the form classifying definition creating unit 33 stores the form classifying definition data allocated with the priority level in the form classifying definition database 22.

While on the other hand, in the case of not performing the recognition test, the form classifying definition creating unit 33 stores the generation-completed form classifying definition data in the form classifying definition database 22.

Incidentally, the recognition test may also be performed separately from generating the form classifying definition data. Further, the setting of whether the recognition test is performed or not is arbitrarily done based on the input information (or the setting by the user) inputted by the user via the user interface or alternatively based on parameters of the program stored in the storage unit 11. The form classifying definition creating unit 33 determines from the setting thereof whether the recognition test is performed or not.

Note that the form classifying definition creating unit 33 can execute a data addition in the same process as the process described above also in the case of adding, e.g., a new record of form classifying definition data (corresponding to the row data (record) of the form classifying definition data illustrated in FIG. 5) to the form classifying definition data. In this case, the form classifying definition creating unit 33 acquires, through the process described above, the classifying target forms and the format definition information used for classifying the forms. Then, the form classifying definition creating unit 33 adds the respective items of information acquired therefrom to the form classifying definition data stored in the form classifying definition database 22.

<Form Classifying Processing Unit 34>

The form classifying processing unit 34 executes at an arbitrary point of time a form classifying process for the form data that is converted into the electronic data by the scanner 2 etc and acquired from the input unit 14. The form classifying processing unit 34 executes the form classifying process by employing the form classifying definition data stored in the form classifying definition database 22. Note that the form data defined as the target data of the form classifying process is arbitrarily inputted and may also be inputted to, e.g., the information processing device 1 via the network.

The form classifying processing unit 34 carries out the form classifying process on the basis of the information stored in the each format definition field of the form classifying definition data.

For instance, in the case of executing the form classifying process based on the information stored in the OCR format definition field, the form classifying processing unit pattern-matches the form data by using the matching information in the OCR format definition field. Then, the form classifying processing unit 34 specifies the classifying definition data of which the pattern matching rate exceeds a predetermined value, and thus identifies the form having the form name given to the classifying definition data from which the classifying process target form data is specified. Moreover, the form classifying processing unit 34 groups, e.g., the classifying process target form data by category into a form-name based group by use of a result of the identification (distinction).

Furthermore, in the case of executing the form classifying process based on the information stored in the barcode format definition field, the form classifying processing unit 34 acquires the barcode from the arbitrary predetermined area, in which the print position of the barcode stored in the barcode format definition field is set as the benchmark. Note that the predetermined area given herein is what takes into consideration the error due to the peripheral environments similarly to the contents described above.

Then, the acquired barcode is decoded by employing the information representing the type of the barcode and the barcode information stored in the barcode format definition field, thereby specifying the classifying definition data to be matched. The data for specifying the classifying definition data to be matched, i.e., the data for classifying the forms, is contained in the barcode information as described above. The form classifying processing unit 34 decodes the acquired barcode and collates the decoded information (data) with the data for classifying the forms that is contained in the barcode information, thereby specifying the classifying definition data matched with the form data. Then, the form classifying processing unit 34 identifies the form having the form name given to the classifying definition data from which the classifying process target form data is specified. Further, the form classifying processing unit 34 groups, e.g., the classifying process target form data by category into the form-name based group by use of the result of the identification. Incidentally, if the barcode can be neither acquired nor decoded, the form classifying processing unit 34 determines that the form data can not be classified based on the classifying definition data. Namely, the form classifying processing unit 34 determines that the classifying definition data is not matched with the form data.

Furthermore, for instance, in the case of carrying out the form classifying process on the basis of the information stored in the specified area OCR format definition field, the form classifying processing unit 34 implements the specified area OCR over the arbitrary predetermined area, in which the coordinate information of the specified area that is stored in the specified area OCR format definition field is set as the benchmark. Note that the predetermined area given herein is what takes into consideration the error due to the peripheral environments similarly to the contents described above.

Then, the classifying definition data to be matched is specified by use of the information acquired by the specified area OCR and the reading information stored in the specified area OCR format definition field. The data for specifying the classifying definition data to be matched, i.e., the data for classifying the forms, is contained in the reading information as described above. The form classifying processing unit 34 collates the information (data) acquired by the specified area OCR with the data for classifying the forms that is contained in the reading information, thereby specifying the classifying definition data matched with the form data. Then, the form classifying processing unit 34 identifies the form having the form name given to the classifying definition data from which the classifying process target form data is specified. Further, the form classifying processing unit 34 groups, e.g., the classifying process target form data by category into the form-name based group by use of the result of the identification. Incidentally, if the information can not be acquired by the specified area OCR, the form classifying processing unit 34 determines that the form data can not be classified based on the classifying definition data. Namely, the form classifying processing unit 34 determines that the classifying definition data is not matched with the form data.

Note that the order of the format definitions undergoing the classifying process may be arbitrarily set. If the priority level is allocated, however, the form classifying processing unit 34 executes the classifying process by employing the format definitions in the order from the highest priority level down to the lowest.

In the embodiment, through the classifying process, the form classifying processing unit 34 performs the recognition test. In the embodiment, the recognition test is carried out for allocating the priority levels used for classifying the forms to the respective format definitions when the form classifying definition creating unit 33 generates the form classifying definition data.

In the embodiment, as described above, the recognition test is performed by the arbitrary setting. When the recognition test is conducted, the form classifying processing unit 34 acquires plural sets of classifying target form data (test data) subjected to the implementation of the recognition test from, e.g., the input unit 14. Herein, for distinguishing between the image data described above and the form data, the form data, which becomes the classifying target data in the recognition test, is called the test data. The test data is the data (electronic data) into which the scanner 2 electronically converts the form in which the form data generated based on, e.g., the form definition data is printed by the printer 3. Further, the test data is the data (electronic data) into which the scanner 2 electrically converts the form created by the user who handwrites, imprints or attaches a seal etc in accordance with, e.g., the form definition data. Moreover, the test data may be arbitrarily inputted such as being inputted to, e.g., the information processing device 1 via the network.

It should be noted that a data count of the data inputted as the test data may be arbitrarily set based on the input information (or the setting by the user) inputted by the user via the user interface or alternatively based on parameters of the program stored in the storage unit 11. Till reaching the thus set-up data count, the form classifying processing unit 34 accepts the test data.

Then, when a count of the accepted the test data reaches the set-up data count, the form classifying processing unit 34 executes the form classifying process with respect to the inputted test data. Subsequently, the form classifying processing unit 34 measures the form classifying rate (recognition rate) per format definition. In the embodiment, the form classifying processing unit 34 measures (calculates) the recognition rate of the form by an arbitrary mathematical technique, e.g., by dividing a number of times (count) the classifying definition data to be matched can be specified when using each format definition by the data count of the test data. Note that the recognition rate may be measured per classifying definition data and may also be measured for the whole form classifying definition data without distinguishing between the respective sets of classifying definition data.

The form classifying processing unit 34, upon completing the measurement of the recognition rate with respect to each format definition, outputs the thus-measured recognition rate to the form classifying definition creating unit 33.

### §3 Operational Example

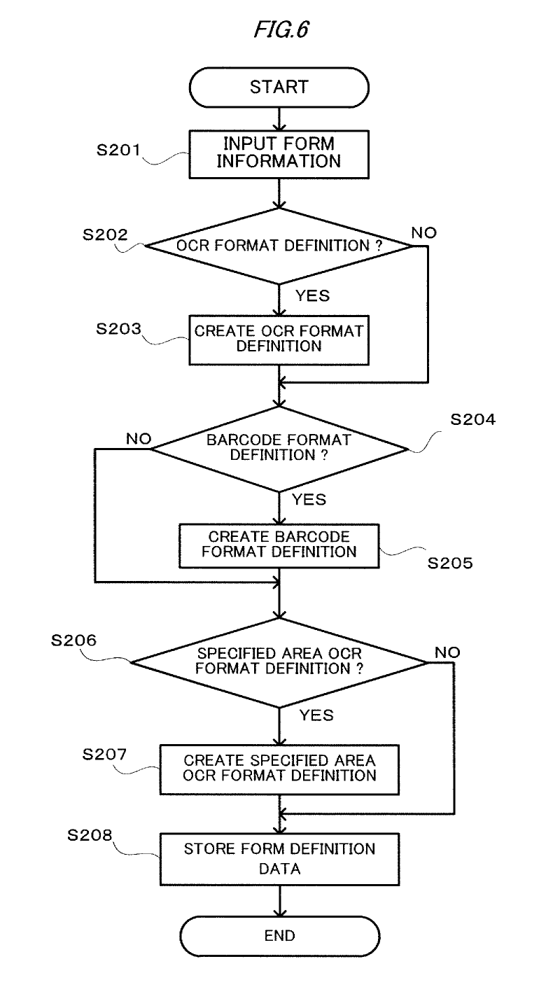

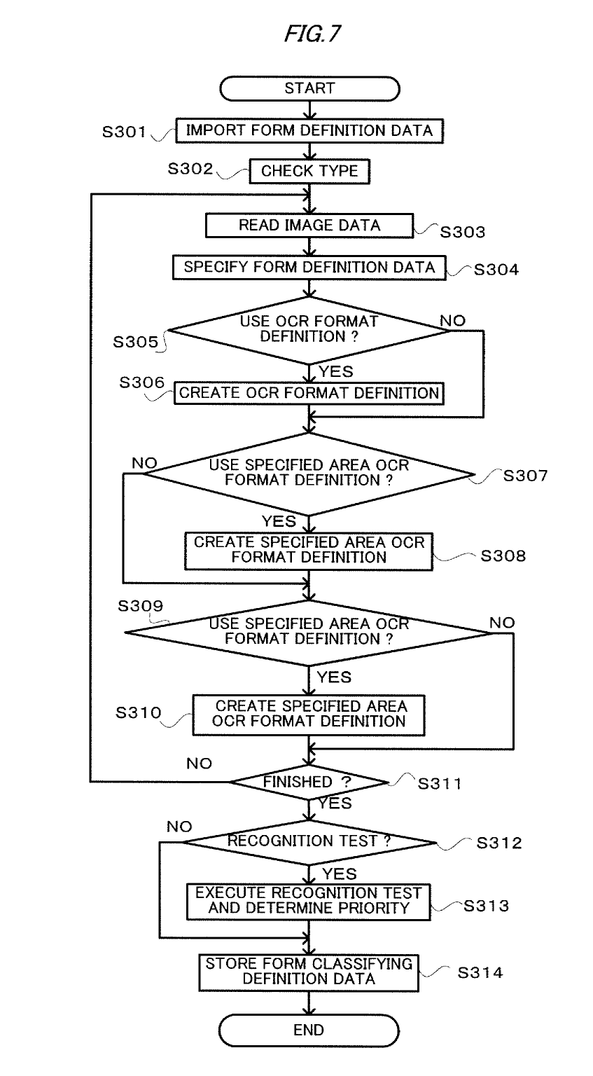

Next, processing procedures of generating the form definition data and the form classifying definition data in the embodiment will hereinafter be described with reference to FIGS. 6 and 7. FIG. 6 illustrates one example of the processing procedures when generating the form definition data in the embodiment. Further, FIG. 7 illustrates one example of the processing procedures when generating the form classifying definition data in the embodiment. Incidentally, the specific processes in respective steps have already been described in [§2 Example of Configuration of Information Processing Device 1], and therefore the descriptions thereof are omitted.

<Generation of Form Definition Data>

At first, a description of how the form definition data is generated will be made with reference to FIG. 6. A start of generating the form definition data is triggered by an event that the program control unit 12 executes the program stored in the storage unit 11 on the basis of, e.g., user's operating information via the user interface.

Upon the start of generating the form definition data, the form definition designing unit 31 provides the user with an interface for inputting the data for creating the form via the user interface. Then, the form definition designing unit 31 acquires the data for creating the form in accordance with the input information from the user via the user interface (S201). Further, the form definition designing unit 31 outputs the data for designing the acquired form to the form definition generating unit 32.

The form definition generating unit 32 prepares the form definition data in the empty status of the data and stores, in the respective subfields, the items of data for creating the form received from the form definition designing unit 31, thus generating the form definition data.

Next, as illustrated in FIG. 6, the form definition generating unit 32 determines whether or not the data for creating the form received from the form definition designing unit 31 contains the data to be stored in the OCR format definition field (S202). Then, if the data for creating the form received from the form definition designing unit 31 contains the data to be stored in the OCR format definition field, the form definition generating unit 32 stores the items of data in the respective subfields of the OCR format definition field of the prepared form definition data (S203).

Next, the form definition generating unit 32 determines whether or not the data for creating the form received from the form definition designing unit 31 contains the data to be stored in the barcode format definition field (S204). Then, if the data for creating the form received from the form definition designing unit 31 contains the data to be stored in the barcode format definition field, the form definition generating unit 32 stores the items of data in the respective subfields of the barcode format definition field of the prepared form definition data (S205).

Next, the form definition generating unit 32 determines whether or not the data for creating the form received from the form definition designing unit 31 contains the data to be stored in the specified area OCR format definition field (S206). Then, if the data for creating the form received from the form definition designing unit 31 contains the data to be stored in the specified area OCR format definition field, the form definition generating unit 32 stores the items of data in the respective subfields of the specified area OCR format definition field of the prepared form definition data (S207).

Through the processes, upon a completion of storing the data in the prepared form definition data, the form definition generating unit 32 completes generating the form definition data. Subsequently, the form definition generating unit 32 stores the form definition data reaching a generation-completed status in the form definition database 21 (S208). The processes related to the generation of the form definition data are completed.

<Generation of Form Classifying Definition Data>

Next, a description of how the form classifying definition data is generates will be made with reference to FIG. 7. A start of generating the form classifying definition data is, similarly to the generation of the form definition data, triggered by an event that the program control unit 12 executes the program stored in the storage unit 11 on the basis of, e.g., user's operating information via the user interface.

Upon the start of generating the form classifying definition data, the form classifying definition creating unit 33 acquires the form definition data from the form definition database 21 (S301). Then, the form classifying definition creating unit 33 checks a data format of the acquired form definition data (S302).

Subsequently, the form classifying definition creating unit 33 accepts the input of the image data (S303). For instance, the form classifying definition creating unit 33, as the form converted into the electronic data by the scanner 2 is inputted as the image data to the input unit 14, acquires the image data from the input unit 14.

The form classifying definition creating unit 33, when acquiring the image data, specifies the form definition data associated with the image data (S304). The in-depth description thereof is as given above.

Upon specifying the form definition data, the form classifying definition creating unit 33 prepares the empty form classifying definition data and the empty classifying definition data for an addition as the row data to the empty classifying form definition data.

Subsequently, the form classifying definition creating unit 33 determines whether or not the OCR format definition is used for classifying the form targeted at generating the classifying definition data (S305). Then, when determining that the OCR format definition is used for classifying the form, the form classifying definition creating unit 33 stores the form definition data associated with the image data and the information generated or acquired from the image data in the respective subfields of the OCR format definition field of the classifying definition data (S306). While on the other hand, when determining that the OCR format definition is not used for classifying the form, the form classifying definition creating unit 33 omits the process in S306.

Subsequently, the form classifying definition creating unit 33 determines whether or not the barcode format definition is used for classifying the form targeted at generating the classifying definition data (S307). Then, when determining that the barcode format definition is used for classifying the form, the form classifying definition creating unit 33 stores the form definition data associated with the image data and the information generated or acquired from the image data in the respective subfields of the barcode format definition field of the classifying definition data (S308). While on the other hand, when determining that the barcode format definition is not used for classifying the form, the form classifying definition creating unit 33 omits the process in S308.

Subsequently, the form classifying definition creating unit 33 determines whether or not the specified area OCR format definition is used for classifying the form targeted at generating the classifying definition data (S309). Then, when determining that the specified area OCR format definition is used for classifying the form, the form classifying definition creating unit 33 stores the form definition data associated with the image data and the information generated or acquired from the image data in the respective subfields of the specified area OCR format definition field of the classifying definition data (S310). While on the other hand, when determining that the specified area OCR format definition is not used for classifying the form, the form classifying definition creating unit 33 omits the process in S310.

Through the processes in S303-S310, the form classifying definition creating unit 33 completes generating the classifying definition data. Then, the form classifying definition creating unit 33 adds the classifying definition data reaching the generation-completed status as the row data of the form classifying definition data. When the classifying definition data is added to the form classifying definition data, the form classifying definition creating unit 33 determines whether the generation of the classifying definition data is terminated or not (S311). When determining that the generation of the classifying definition data is not terminated, the form classifying definition creating unit 33 repeats the processes again from, e.g., S303.

While on the other hand, when determining that the generation of the classifying definition data is terminated, the form classifying definition creating unit 33 completes generating the form classifying definition data. Subsequently, the form classifying definition creating unit 33 determines whether the recognition test for the form classifying definition data reaching the generation-completed status is performed or not (S312).

When determining that the recognition test for the form classifying definition data reaching the generation-completed status is not performed, the form classifying definition creating unit 33 stores the form classifying definition data reaching the generation-completed status in the form classifying definition database 22 (S314), and completes the processes related to the generation of the form classifying definition data.

Whereas if it is determined that the recognition test for the form classifying definition data reaching the generation-completed status is performed, the form classifying processing unit 34 carries out the recognition test of the form classifying process by using the form classifying definition data reaching the generation-completed status attained by the form classifying definition creating unit 33 (S313). Then, the form classifying processing unit 34 measures the recognition rate in the form classifying process of each format definition from a result of the recognition test. When completing the measurement, the form classifying processing unit 34 outputs the thus-measured recognition rate to the form classifying definition creating unit 33. The form classifying definition creating unit 33, when receiving the recognition rate measured by the form classifying processing unit 34, determines the priority level employed for classifying the form with respect to each format definition. Then, the form classifying definition creating unit 33 sets the determined priority level with respect to each format definition. Upon a completion of setting the priority level, the form classifying definition creating unit 33 stores the form classifying definition data reaching a setting-completed status of the priority level in the form classifying definition database 22 (S314), and completes the processes related to the generation of the form classifying definition data.

### §4 Operations and Effects of Embodiment

According to what has been discussed so far, in the information processing device of the embodiment, the form definition data generated based on the input information of the user is matched with the image data captured by the scanner etc, thereby generating the form classifying definition data for classifying the forms. Accordingly, even if the image data to be captured fluctuates depending on the peripheral environments, it is feasible to generate the form classifying definition data adapted to the fluctuation. Owing to this adaptation, the information processing device according to the embodiment can generate the classifying definition adequate to each individual user.

Moreover, in the information processing device 1 of the embodiment, the storage unit 11 may be stored with plural sets of form definition data. Then, the control unit 12 may recognize the components of the image data and may acquire the form definition data associated with the image data by collating the form definition data containing the format definition matched with the recognized components of the image data with the form definition data taken from within the storage unit 11.

According to the configuration described above, the form definition data containing the format definition matched with the recognized components of the image data is collated with the form definition data taken from within the storage unit 11, thereby acquiring the form definition data associated with the image data. With this contrivance, according to the configuration described above, even when the user does not specify the form definition data used for generating the information for distinction, which enables the forms to be distinguished therebetween from the components thereof, the information for distinction can be generated.

Yet further, the form format definition contained in the form definition data may contain a plurality of format definitions. Moreover, the control unit 12 may generate on a per format definition basis the information for distinction that enables the forms to be distinguished therebetween from the components thereof, which are created based on the plurality of format definitions contained in the form format definitions.

According to the configuration described above, it is possible to generate the information for distinction, which enables the distinction between the forms on the basis of the plurality of format definitions.

Moreover, the information processing device of the embodiment performs the recognition test of the form classifying process with respect to the generated form classifying definition data. Then, as a result of the recognition test, the recognition rate of the form is measured with respect to each format definition used for classifying the forms, which is stored in the form classifying definition data. Furthermore, the priority level used for classifying the forms with respect to each format definition is determined based on the measured recognition rate of the form. Accordingly, the information processing device according to the embodiment sets, even the data to be captured fluctuates depending on the peripheral environments, the priority level adapted to the fluctuation with respect to each format definition. With this contrivance, in the information processing device according to the embodiment, it is possible to generate the proper form classifying definition data by which each individual user can be provided with the order of the format definitions used for classifying the forms in adaptation to the fluctuations of the peripheral environments.

Moreover, in the embodiment, a situation requiring the user to input when generating the data is confined to only the situation of generating the form definition data. In the information processing device according to the embodiment, once the form definition data is generated, the form classifying definition data is generated based on the generated form definition data. Owing to this scheme, according to the information processing device of the embodiment, each individual user has no necessity for dual operations such as creating the definitions for the forms and for the classifying definitions.

### § Modified Examples

The generation of the form definition data, the generation of the form classifying definition data and the form classifying process may be conducted by different devices. In this case, for example, the form definition creating unit 30 which generates the form definition data, the form classifying definition creating unit 33 which generates the form classifying definition data and the form classifying processing unit 34 which executes the form classifying process, are realized by the control units of the separate devices. Further, for instance, the form definition database 21 and the form classifying definition database 22 are shared between or among the separate devices. Then, for example, the data in the respective processes are transmitted and received via the network, thereby realizing the respective processes of the information processing device 1 in the embodiment.

It should be noted that another mode of the embodiment may be an information processing method and may also be a program, which realize the respective configurations described above, and may further be a non-transitory computer-readable medium storing this program. Moreover, still another mode of the embodiment may be a system configured to enable a plurality of devices for realizing the respective configurations described above to communicate with each other.

### § Supplements

The in-depth description of the embodiment of the present invention has been made so far but is no more than an exemplification of the present invention in all aspects as well as not intending to limit the scope of the invention. As a matter of course, a variety of improvements and modifications can be made without deviating from the scope of the present invention.

What is claimed is:

1. An information processing device, comprising:
a storage unit to be stored with form definition data containing format definition of a form;
an input unit to capture image data of the form; and
a control unit to:
compare the image data captured by said input unit with form definition data associated with the image data, and
generate information for distinction that enables the forms to be distinguished therebetween from components thereof by applying a result of the comparison to the form definition data.

2. The information processing device according to claim 1, wherein
said storage unit is stored with plural sets of form definition data, and
said control unit recognizes the components of the image data and acquires the form definition data associated with the image data by collating the form definition data containing the format definition matched with the recognized components of the image data with the form definition data taken from within said storage unit.

3. The information processing device according to claim 1, wherein
the form format definition contained in the form definition data contains a plurality of format definitions, and
said control unit generates, with respect to each of the plurality of format definition, the information for distinction that enables the forms to be distinguished therebetween from the components thereof, which are created based on the each of the plurality of format definitions contained in the form format definitions.

4. The information processing device according to claim 3, wherein
said input unit further captures plural sets of test data, and
said control unit:
distinguishes between the plural sets of test data by use of the information for distinction that is created based on the plurality of format definitions,
obtains a distinction rate of the test data by use of the respective format definitions on the basis of a result of the distinguishability, and
creates the information for distinction in which a priority level employed for distinguishing between the forms on the basis of the obtained distinction rate is defined in each format definition.

5. The information processing device according to claim 3, wherein the plurality of format definitions contains at least one of a format definition in which the format related to an external appearance of the form is defined, a format definition in which an attribute value of a mark for recognizing an optical mark included in the form is defined, and a format definition in which an attribute value related to character recognition implemented in a specified area is defined.

6. The information processing device according to claim 1, wherein
the form format definition contained in the form definition data contains at least one of the format definition in which the format related to the external appearance of the form is defined, the format definition in which the attribute value of the mark for recognizing the optical mark included in the form is defined, and the format definition in which the attribute value related to the character recognition implemented in the specified area is defined, and
said control unit generates the information for distinction that enables the forms to be distinguished therebetween from the components thereof, which are created based on the format definitions contained in the form format definitions.

7. An information processing method by which a computer executes:
capturing image data of a form;
comparing the captured image data with form definition data associated with the image data; and
generating information for distinction that enables the forms to be distinguished therebetween from components thereof by applying a result of the comparison to the form definition data.

8. A non-transitory computer-readable medium storing a program to make a computer execute:
capturing image data of a form;
comparing the captured image data with form definition data associated with the image data; and
generating information for distinction that enables the forms to be distinguished therebetween from components thereof by applying a result of the comparison to the form definition data.
